(19) United States
(12) Patent Application Publication
(10) Pub. No.: US 2022/0383130 A1
(43) Pub. Date: Dec. 1, 2022

(54) SYSTEM, DEVICES AND/OR PROCESSES FOR SELF-SUPERVISED MACHINE-LEARNING

(71) Applicant: AKASA, Inc., South San Francisco, CA (US)

(72) Inventors: Byung-Hak Kim, San Jose, CA (US); Hariraam Varun Ganapathi, San Francisco, CA (US)

(21) Appl. No.: 17/575,852

(22) Filed: Jan. 14, 2022

Related U.S. Application Data
(60) Provisional application No. 63/194,139, filed on May 27, 2021.

(51) Int. Cl. G06N 3/08; G06N 3/04; G10L 15/26

(52) U.S. Cl. CPC G06N 3/088; G06N 3/0454; G10L 15/26

(57) ABSTRACT

Example methods, apparatuses, and/or articles of manufacture are disclosed that may be implemented, in whole or in part, using one or more computing devices to implement one or more self-supervised machine-learning techniques. In a particular implementation, first and second mappings may map features of an electronic document to associated first and second encoded domains.

This application claims the benefit of priority under 35 USC § 119 (e) to U.S. Provisional Patent Application No. 63/194,139, titled “SYSTEM, DEVICES AND/OR PROCESSES FOR SELF-SUPERVISED MACHINE-LEARNING,” filed on May 27, 2021, and incorporated herein by reference in its entirety.

### BACKGROUND

### 1. Field

The present disclosure relates generally to machine-learning devices.

### 2. Information

Developments in self-supervised learning (SSL) have yielded visual representations having associated accuracy approaching an accuracy of visual representations obtained from fully supervised learning on large computer vision downstream tasks. To date, most SSL studies and systems have been directed to applications of well-curated data sets.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a schematic diagram of a computing apparatus, according to an embodiment;

FIG. 2 is a flow diagram of a process to determine parameters for mappings features of an electronic document to associated content domains, according to an embodiment; and

FIG. 3 is a schematic block diagram of an example computing system in accordance with an implementation.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the disclosure, particular context of description and/or usage provides helpful guidance regarding reasonable inferences to be drawn; however, likewise, “in this context” in general without further qualification refers at least to the context of the present patent application.

As pointed out above, self-supervised learning (SSL) techniques have yielded visual representations having an associated accuracy that approaches a level of accuracy enabled using fully supervised learning on large computer vision downstream tasks, for example.

While some implementations of an SSL are directed to use of well-curated datasets, particular embodiments disclosed herein are directed to applications of structured document images. In a particular implementation, to develop an SSL approach for structured document images, an information bottleneck framework may be applied to derive a negative-sample-free contrastive learning objective. This may lead to simplified objective function that avoids negative pair construction and strong dependency on use of large batch sizes.

Briefly, one particular embodiment is directed to first and second mappings to map features of an electronic document to different associated first and second encoded content domains. According to embodiment, by transforming features mapped to the first and second encoded domains to a common domain, features mapped to the first encoded domain may be applied as a supervisory signal in a SSL machine-learning process to further refine parameters of the second mapping to map features of the electronic domain to the second encoded content domain.

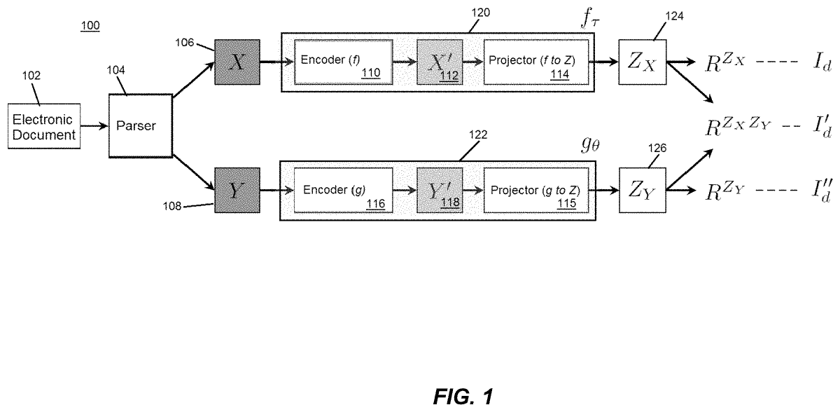

FIG. 1 is a schematic diagram of aspects of a computing apparatus 100 implementing a system to facilitate an SSL machine-learning technique, according to an embodiment. An electronic document 102 may be received at parser 104 to provide patch sequences X and Y. In a particular implementation, electronic document 102 may comprise signals expressing content in any one of several forms including, for example, image pixels, audio signals, sensor observations or measurements, raw sensor signals or content encoded according to a particular encoded format (e.g., JPEG, MPEG, MP3, ASCI, etc.), or a combination thereof, just to provide a few examples.

According to an embodiment, parser 104 may generate patch sequences X and Y based, at least in part, on features detected in and/or extracted from electronic document 102. In a particular implementation, parser 104 may generate patch sequences X and Y based, at least in part, on features detected in and/or extracted from electronic document 102 in different content domains for respective patch sequences X and Y. In one particular example, electronic document 102 may comprise image pixel values expressing a mixture of objects including text objects and non-text objects (e.g., objects visible in a scene such as humans, written document formatting features, animals, plants, building structures, commercial products, etc.). Here, parser 104 may generate patch sequence X as non-text objects detected in and/or extracted from electronic document 102 while generating patch sequence Y as a text sequence, for example. To generate patch sequence Y as a text sequence, for example, parser 104 may implement optical character recognition to detect and/or extract text objects from pixel values in electronic document 102. In another example, electronic document 102 may comprise an audio signal including a mixture of components including, for example, human voices, sounds from a machine, a barking dog, automobile horn, etc. Here, parser 104 may generate patch sequence X as non-human voice features detected in and/or extracted from electronic document 102 (e.g., non-human sounds expressed in electronic document 102) while generating patch sequence Y as text of words/phrases detected in and/or extracted from a human voice component of sounds expressed in electronic document 102. To generate patch sequence Y as a text sequence, for example, parser 104 may implement a voice-to-text process to detect and/or extract text objects from an audio signal in electronic document 102 identified as being from of a human voice. It should be understood, however, that these are merely examples of how a parser may generate different patch sequences from an electronic document in respectively different content domains, and claimed subject matter is not limited in this respect.

According to an embodiment, processing path 120 may process patch sequence X according to a first content domain and processing path 122 may process patch sequence X according to a second content domain distinct and different from the first content domain. Nonetheless, processing paths 120 and 122 map outputs to a common domain. According to an embodiment, encoders 110 and 116 may map features in patch sequences X and Y to respectively different encoded domains content domains 112 (as encoded patch sequence X′) and 118 (as encoded patch sequence Y′), for example. If features expressed electronic document 102 are parsed into patch sequences X and Y respectively having text features and visual object features (as in the above example), encoded patch sequency X′ may comprise symbols and/or expressions encoded to represent text features and encoded patch sequence Y′ may comprise symbols and/or expressions encoded to represent visual object features. Similarly, if audio signal features expressed electronic document 102 are parsed into patch sequences X and Y respectively having voice-to-text features and non-human sound features, encoded patch sequence X′ may comprise symbols and/or expressions encoded to represent text features and encoded patch sequence Y′ may comprise symbols and/or expressions encoded to represent non-human sound/audio features, for example. Likewise, if visually rich content in electronic document 102 is parsed into patch sequences X and Y respectively having text features and visual object features, encoded patch sequency X′ may comprise symbols and/or expressions encoded to text sequence and encoded patch sequence Y′ may comprise symbols and/or expressions encoded to represent a corresponding region image sequence. In another example, if an instructional audio-visual presentation in electronic document 102 is parsed into patch sequences X and Y respectively having an instructor's voice features and visual image features, encoded patch sequency X′ may comprise symbols and/or expressions encoded to represent the instructor's narrative (e.g., in audio symbols and/or text symbols) and encoded patch sequence Y′ may comprise symbols and/or expressions encoded to represent a corresponding series of video images. In yet another example, if a medical record in electronic document 102 is parsed into patch sequences X and Y respectively having a representation of clinical notes (e.g., in audio or written format) and features of an X-ray image, encoded patch sequence X′ may comprise symbols and/or expressions encoded to represent a clinician's description (e.g., in audio symbols and/or text) and encoded patch sequence Y′ may comprise symbols and/or expressions encoded to represent a corresponding series of still images.

While encoded patch sequences X′ and Y′ may comprise symbols and/or expressions to represent features in different content domains, such symbols and/or expressions represented in encoded patch sequences X′ and Y′ may nonetheless be correlated. For example, such symbols and/or expressions represented in encoded patch sequences X′ and Y′ may be correlated with respect to a time domain, environmental context domain, situational context domain, just to provide a few examples. According to an embodiment, such a correlation of symbols and/or expressions represented in encoded patch sequences X′ and Y′ may enable use of symbols and/or expressions in encoded patch sequence X′ to derive a supervisory signal to assist in a machine-learning process to refine parameters defining processing paths 120 and 122.

According to an embodiment, projectors 114 and 115 may transform symbols and/or expressions in encoded patch sequences X′ and Y′ to a common domain Z, where Zₓ and Z_{y} respectively represent transformation of symbols and/or expressions in encoded patch sequences X′ and Y′ to common domain Z. In a particular implementation, such mapping of encoded patch sequences X′ and Y′ to a common domain Z as Zₓ and Z_{y} may enable one or more machine-learning processes to derive parameters for elements of processing paths 120 and 122 (e.g., encoders 110 and 116, and projectors 114 and 115), for example. In a particular example implementation, encoders 110 and 116, and projectors 114 and 116 may be implemented, at least in part, using neural networks and a machine-learning process may updating/refining aspects of such neural networks based, at least in part, on Zₓ and Z_{y} using backpropagation, for example.

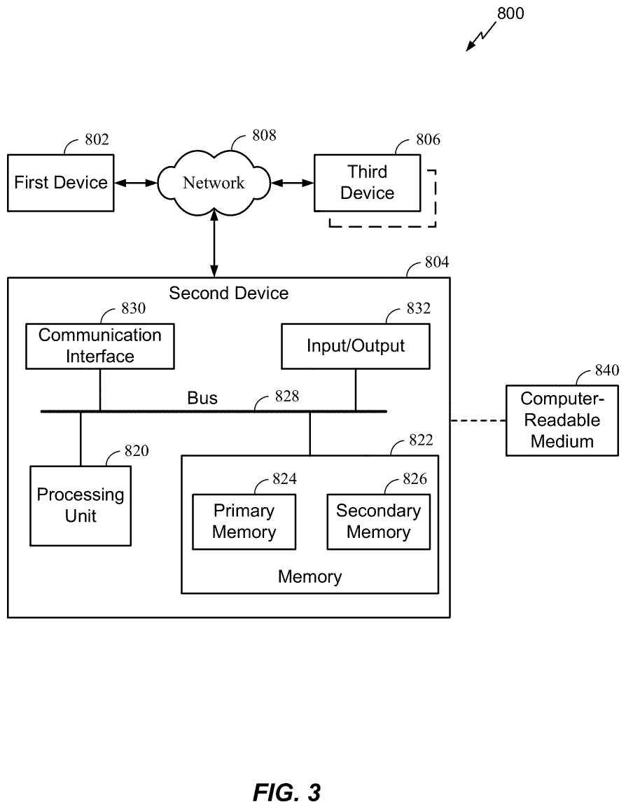

According to an embodiment, a neural network (e.g., as implemented in encoders 110 and 116, and/or projectors 114 and 116 according to particular implementations), may comprise a graph comprising nodes to model neurons in a brain. In this context, a “neural network” as referred to herein means an architecture of a processing device defined and/or represented by a graph including nodes to represent neurons that process input signals to generate output signals, and edges connecting the nodes to represent input and/or output signal paths between and/or among the artificial neurons represented by the graph. In particular implementations, a neural network may comprise a biological neural network, made up of real biological neurons. Alternatively, a neural network may comprise an artificial neural network made up of artificial neurons for solving artificial intelligence (AI) problems, for example. In an implementation, such an artificial neural network may be implemented one or more computing devices such as computing devices shown in FIG. 3. In a particular implementation, weights associated with edges to represent input and/or output paths may reflect gains to be applied and/or whether an associated connection between connected nodes is to be excitatory (e.g., weight with a positive value) or inhibitory connections (e.g., weight with negative value). In an example implementation, a neural may apply a weight to input signals, and sum weighted input signals to generate a linear combination.

Edges in a neural network connecting nodes may model synapses capable of transmitting signals (e.g., represented by real number values) between neurons. Receiving such a signal at a node in a neural network, the node may perform some computation to generate an output signal (e.g., to be provided to another node in the neural network connected by an edge) based, at least in part, on one or more weights and/or numerical coefficients associated with the node and/or edges providing the output signal. In a particular implementation, such weights and/or numerical coefficients may be adjusted and/or updated as learning progresses. For example, such a weight may increase or decrease a strength of an output signal. In an implementation, transmission of an output signal from a node in a neural network may be inhibited if a strength of the output signal does not exceed a threshold value.

According to an embodiment, a neural network may be structured in layers such that a node in a particular neural network layer may receive output signals from one or more nodes in a previous layer in the neural network, and provide an output signal to one or more nodes in a subsequent layer in the neural network. One specific class of layered neural networks may comprise a convolutional neural network (CNN) or space invariant artificial neural networks (SIANN) that enable deep learning. Such CNNs and/or SIANNs may be based on a shared-weight architecture of a convolution kernels that shift over input features and provide translation equivariant responses. Such CNNs and/or SIANNs may be applied to image and/or video recognition, recommender systems, image classification, image segmentation, medical image analysis, natural language processing, brain-computer interfaces, financial time series, just to provide a few examples.

In particular implementations, neural networks may enable improved results in a wide range of tasks, including image recognition, speech recognition, just to provide a couple of example applications. To enable performing such tasks, features of a neural network (e.g., nodes, edges, weights, layers of nodes and edges) may be structured and/or configured to form “filters” that may have a measurable/numerical state such as a value of an output signal. Such a filter may comprise nodes and/or edges arranged in “paths” and are to be responsive to features (e.g., content features detected in and/or extracted from an electronic document) as input signals. In an implementation, a state and/or output signal of such a filter may indicate and/or infer detection of a presence or absence of a content feature in a particular domain.

According to an embodiment, features of neural networks to implement encoders 110 and 116, and projectors 114 and 116 (e.g., weights and/or numerical coefficients to be applied to and/or associated with nodes and/or edges in such neural networks) may be determined, adjusted and/or updated according to a loss function [symbol] in expression (1) as follows:

$$\begin{matrix}ℒ = I ( {Z}_{X} ; X ) + I ( {Z}_{Y} ; Y ) - α I ( {Z}_{X} ; {Z}_{Y} ) \\ = \begin{matrix}( {Z}_{X} ) - h ( {Z}_{X} \vert X ) - h ( {Z}_{Y} ) - h ( {Z}_{Y} \vert Y ) - \\ hα h ( {Z}_{X} ) - α h ( {Z}_{Y} ) + α h ( {Z}_{X} , {Z}_{Y} )\end{matrix} \\ = ( 1 - α ) h ( {Z}_{X} ) + ( 1 - α ) h ( {Z}_{Y} ) + α h ( {Z}_{X} , {Z}_{Y} ) ,\end{matrix} \qquad ( 1 )$$

where:

I(Z_{X};X) represents mutual information of Z_{X} and patch sequence X;

I(Z_{Y}; Y) represents mutual information of Z_{Y} and patch sequence Y;

I(Z_{X}; Z_{Y} X) represents mutual information of Z_{X} and Z_{Y}; and

h is a function representing differential entropy.

In a particular implementation, Z_{X} and Z_{Y} may be modeled as two jointly multivariate Gaussian variables with zero means and covariance matrices K_{X}∈ [symbol] ^{d×d} and K_{Y} ∈ [symbol] ^{d×d}, which may be full rank. In an embodiment, entropy of a d-dimensional Gaussian variable may be modeled according to expression (2) as follows:

$$h ( Z ) = \frac{1}{2} log ( {( 2 π e )}^{d} \vert {K}_{Z} \vert ) , \qquad ( 2 )$$

where |K_{Z}| denotes a determinate of K_{Z}. A loss function of expression (1) may they be reduced as shown in expression (3) as follows:

[symbol]

=log(|K_{Z}_{_{X}}|)+log(|K_{Z}_{_{Y}}|)+β log(|K_{Z}_{_{X}}_{Z}_{_{Y}}|), (3)

where:

K_{Z}_{_{X}} is a covariance matrix of Z_{X};

K_{Z}_{_{Y}} is a covariance matrix of Z_{Y};

K_{Z}_{_{X}}_{Z}_{_{Y}} is a cross-covariance matrix of Z_{X} and Z_{Y};

$$β {=}^{△} ( \frac{1 - α}{α} ) .$$

According to an embodiment, an upper bound of log (|K|) may be modeled according to expression (4) as follows:

$$log ( \vert K \vert ) = log ( {\prod }_{i = 1}^{n} {λ}_{i} ) = {\sum }_{i = 1}^{n} log {λ}_{i} < {\sum }_{i = 1}^{n} {λ}_{i}^{2} = {‖ K ‖}_{F}^{2} , \qquad ( 4 )$$

where:

λ₁, λ₂, . . . , λₙ are eigenvalues of covariance matrix K; and

∥⋅∥ is the Frombenius norm.

Applying an upper bound of expression (4) with a target loss function in expression (3) may provide a simplified loss function [symbol] ′ according to expression (5) as follows:

[symbol]

=∥K_{Z}_{_{X}}∥_{F}²+∥K_{Z}_{_{Y}}∥_{F}²+β∥K_{Z}_{_{X}}_{Z}_{_{Y}}∥_{F}². (5)

Since Z_{X} and Z_{Y} are zero mean, a cross-covariance matrix K_{Z}_{_{X}}_{Z}_{_{Y}} may reduce to a cross-correlation matrix R^{Z}^{_{X}}^{Z}^{_{Y}}, assuming normalization without loss of generality. Similarly, auto-covariance matrices K_{Z}_{_{X}} and K_{Z}_{_{Y}} may reduce to auto-correlation matrices R^{Z}^{_{X}} and R^{Z}^{_{Y}}, respectively. According to an embodiment, matrices to express R^{Z}^{_{X}}^{Z}^{_{Y}}, R^{Z}^{_{X}} and R^{Z}^{_{Y}} may be minimized by driving diagonal terms to approach one, and all off-diagonal terms to approach zero. Accordingly, a resulting objective function [symbol] _{SSL} may be set forth according to expression (6) as follows:

$${ℒ}_{SSL} = {\sum }_{i} {( 1 - {R}_{ii}^{{Z}_{X}} )}^{2} + {\sum }_{i} {( 1 - {R}_{ii}^{{Z}_{Y}} )}^{2} + β {\sum }_{i} {( 1 - {R}_{ii}^{{Z}_{X} {Z}_{Y}} )}^{2} + v {\sum }_{i} {\sum }_{j \neq i} {( {R}_{ij}^{{Z}_{X}} )}^{2} + v {\sum }_{i} {\sum }_{j \neq i} {( {R}_{ij}^{{Z}_{Y}} )}^{2} + μ {\sum }_{i} {\sum }_{j \neq i} {( {R}_{ij}^{{Z}_{X} {Z}_{Y}} )}^{2} , \qquad ( 6 )$$

where μ and ν are hyper-parameters controlling diagonal and off-diagonal terms of corresponding matrices.

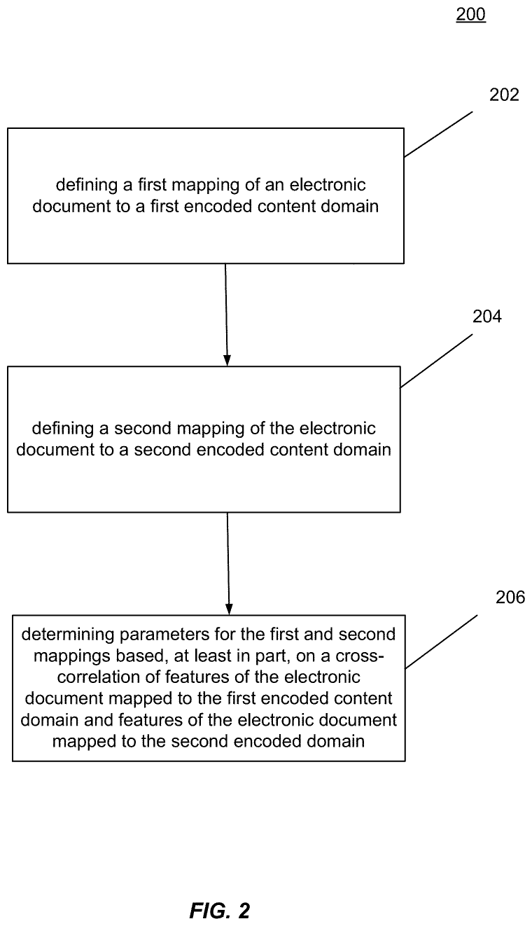

FIG. 2 is a flow diagram of a process 200 for determining parameters of mappings of features expressed in an electronic document to different content domains. In a particular implementation, process 200 may be performed, in whole or in part, by one or more computing devices such as computing devices as shown in FIG. 3, for example. Blocks 202 and 204 may comprise defining and/or executing different processing paths to be applied to parsed features of an electronic document. For example, block 202 may comprise defining and/or executing processing path processing patch sequence X in processing path 120 to generate encoded patch sequence X′ and/or Z_{X}.

Likewise, while block 204 may comprise processing patch sequence Y in processing path 122 to generate encoded patch sequence Y′ and/or Z_{Y}. In the particular embodiment shown in FIG. 1, for example, a processing path defined and/or executed by block 202 may be tailored based on a function/mapping ƒ_{T} while a processing path defined and/or executed by block 204 may be tailored based on a function/mapping g_{θ}. Here, it should be recognized that function/mappings ƒ_{T} and g_{θ} are distinct from one another.

Block 206 may comprise a determination of parameters that at least in part define first and second mappings defined and/or executed in blocks 204 and 206, respectively. In a particular example implementation, block 206 may comprise determining parameters for neural networks that implement processing paths 120 and 122. For example, block 206 may comprise determining weights and/or numerical coefficients of neural networks implementing encoders 110 and 116, and projectors 114 and 115. In a particular implementation, block 206 may determine such weights and/or numerical coefficients of neural networks implementing encoders 110 and 116, and projectors 114 and 115 using backpropagation so as to minimize a loss function established according to expression (6), for example.

With an encoding of parsed content features to different encoded content domains in different processing paths 120 and 122, block 206 may enable SSL to converge to acceptably accurate and/or reliable results with fewer/smaller sample batches.

In the context of the present patent application, the term “connection,” the term “component” and/or similar terms are intended to be physical but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, particularly a wireless network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, “coupled” is also used to mean that two or more tangible components and/or the like are not necessarily tangibly in direct physical contact, but are able to co-operate, liaise, and/or interact, such as, for example, by being “optically coupled.” Likewise, the term “coupled” is also understood to mean indirectly connected. It is further noted, in the context of the present patent application, since memory, such as a memory component and/or memory states, is intended to be non-transitory, the term physical, at least if used in relation to memory necessarily implies that such memory components and/or memory states, continuing with the example, are tangible.

Unless otherwise indicated, in the context of the present patent application, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Likewise, the term “based on” and/or similar terms are understood as not necessarily intending to convey an exhaustive list of factors, but to allow for existence of additional factors not necessarily expressly described.

Furthermore, it is intended, for a situation that relates to implementation of claimed subject matter and is subject to testing, measurement, and/or specification regarding degree, that the particular situation be understood in the following manner. As an example, in a given situation, assume a value of a physical property is to be measured. If alternatively reasonable approaches to testing, measurement, and/or specification regarding degree, at least with respect to the property, continuing with the example, is reasonably likely to occur to one of ordinary skill, at least for implementation purposes, claimed subject matter is intended to cover those alternatively reasonable approaches unless otherwise expressly indicated. As an example, if a plot of measurements over a region is produced and implementation of claimed subject matter refers to employing a measurement of slope over the region, but a variety of reasonable and alternative techniques to estimate the slope over that region exist, claimed subject matter is intended to cover those reasonable alternative techniques unless otherwise expressly indicated.

To the extent claimed subject matter is related to one or more particular measurements, such as with regard to physical manifestations capable of being measured physically, such as, without limit, temperature, pressure, voltage, current, electromagnetic radiation, etc., it is believed that claimed subject matter does not fall with the abstract idea judicial exception to statutory subject matter. Rather, it is asserted, that physical measurements are not mental steps and, likewise, are not abstract ideas.

It is noted, nonetheless, that a typical measurement model employed is that one or more measurements may respectively comprise a sum of at least two components. Thus, for a given measurement, for example, one component may comprise a deterministic component, which in an ideal sense, may comprise a physical value (e.g., sought via one or more measurements), often in the form of one or more signals, signal samples and/or states, and one component may comprise a random component, which may have a variety of sources that may be challenging to quantify. At times, for example, lack of measurement precision may affect a given measurement. Thus, for claimed subject matter, a statistical or stochastic model may be used in addition to a deterministic model as an approach to identification and/or prediction regarding one or more measurement values that may relate to claimed subject matter.

For example, a relatively large number of measurements may be collected to better estimate a deterministic component. Likewise, if measurements vary, which may typically occur, it may be that some portion of a variance may be explained as a deterministic component, while some portion of a variance may be explained as a random component. Typically, it is desirable to have stochastic variance associated with measurements be relatively small, if feasible. That is, typically, it may be preferable to be able to account for a reasonable portion of measurement variation in a deterministic manner, rather than a stochastic matter as an aid to identification and/or predictability.

Along these lines, a variety of techniques have come into use so that one or more measurements may be processed to better estimate an underlying deterministic component, as well as to estimate potentially random components. These techniques, of course, may vary with details surrounding a given situation. Typically, however, more complex problems may involve use of more complex techniques. In this regard, as alluded to above, one or more measurements of physical manifestations may be modelled deterministically and/or stochastically. Employing a model permits collected measurements to potentially be identified and/or processed, and/or potentially permits estimation and/or prediction of an underlying deterministic component, for example, with respect to later measurements to be taken. A given estimate may not be a perfect estimate; however, in general, it is expected that on average one or more estimates may better reflect an underlying deterministic component, for example, if random components that may be included in one or more obtained measurements, are considered. Practically speaking, of course, it is desirable to be able to generate, such as through estimation approaches, a physically meaningful model of processes affecting measurements to be taken.

In some situations, however, as indicated, potential influences may be complex. Therefore, seeking to understand appropriate factors to consider may be particularly challenging. In such situations, it is, therefore, not unusual to employ heuristics with respect to generating one or more estimates. Heuristics refers to use of experience related approaches that may reflect realized processes and/or realized results, such as with respect to use of historical measurements, for example. Heuristics, for example, may be employed in situations where more analytical approaches may be overly complex and/or nearly intractable. Thus, regarding claimed subject matter, an innovative feature may include, in an example embodiment, heuristics that may be employed, for example, to estimate and/or predict one or more measurements.

It is further noted that the terms “type” and/or “like,” if used, such as with a feature, structure, characteristic, and/or the like, using “optical” or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be substantially present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present patent application merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

The term electronic file and/or the term electronic document are used throughout this document to refer to a set of stored memory states and/or a set of physical signals associated in a manner so as to thereby at least logically form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

A Hyper Text Markup Language (“HTML”), for example, may be utilized to specify digital content and/or to specify a format thereof, such as in the form of an electronic file and/or an electronic document, such as a Web page, Web site, etc., for example. An Extensible Markup Language (“XML”) may also be utilized to specify digital content and/or to specify a format thereof, such as in the form of an electronic file and/or an electronic document, such as a Web page, Web site, etc., in an embodiment. Of course, HTML and/or XML are merely examples of “markup” languages, provided as non-limiting illustrations. Furthermore, HTML and/or XML are intended to refer to any version, now known and/or to be later developed, of these languages. Likewise, claimed subject matter are not intended to be limited to examples provided as illustrations, of course.

In the context of the present patent application, the terms “entry,” “electronic entry,” “document,” “electronic document,” “content”, “digital content,” “item,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format). Likewise, in the context of the present patent application, digital content provided to a user in a form so that the user is able to readily perceive the underlying content itself (e.g., content presented in a form consumable by a human, such as hearing audio, feeling tactile sensations and/or seeing images, as examples) is referred to, with respect to the user, as “consuming” digital content, “consumption” of digital content, “consumable” digital content and/or similar terms. For one or more embodiments, an electronic document and/or an electronic file may comprise a Web page of code (e.g., computer instructions) in a markup language executed or to be executed by a computing and/or networking device, for example. In another embodiment, an electronic document and/or electronic file may comprise a portion and/or a region of a Web page. However, claimed subject matter is not intended to be limited in these respects.

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

Also, in the context of the present patent application, the term “parameters” (e.g., one or more parameters), “values” (e.g., one or more values), “symbols” (e.g., one or more symbols) “bits” (e.g., one or more bits), “elements” (e.g., one or more elements), “characters” (e.g., one or more characters), “numbers” (e.g., one or more numbers), “numerals” (e.g., one or more numerals) or “measurements” (e.g., one or more measurements) refer to material descriptive of a collection of signals, such as in one or more electronic documents and/or electronic files, and exist in the form of physical signals and/or physical states, such as memory states. For example, one or more parameters, values, symbols, bits, elements, characters, numbers, numerals or measurements, such as referring to one or more aspects of an electronic document and/or an electronic file comprising an image, may include, as examples, time of day at which an image was captured, latitude and longitude of an image capture device, such as a camera, for example, etc. In another example, one or more parameters, values, symbols, bits, elements, characters, numbers, numerals or measurements, relevant to digital content, such as digital content comprising a technical article, as an example, may include one or more authors, for example. Claimed subject matter is intended to embrace meaningful, descriptive parameters, values, symbols, bits, elements, characters, numbers, numerals or measurements in any format, so long as the one or more parameters, values, symbols, bits, elements, characters, numbers, numerals or measurements comprise physical signals and/or states, which may include, as parameter, value, symbol bits, elements, characters, numbers, numerals or measurements examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

Signal packet communications and/or signal frame communications, also referred to as signal packet transmissions and/or signal frame transmissions (or merely “signal packets” or “signal frames”), may be communicated between nodes of a network, where a node may comprise one or more network devices and/or one or more computing devices, for example. As an illustrative example, but without limitation, a node may comprise one or more sites employing a local network address, such as in a local network address space. Likewise, a device, such as a network device and/or a computing device, may be associated with that node. It is also noted that in the context of this patent application, the term “transmission” is intended as another term for a type of signal communication that may occur in any one of a variety of situations. Thus, it is not intended to imply a particular directionality of communication and/or a particular initiating end of a communication path for the “transmission” communication. For example, the mere use of the term in and of itself is not intended, in the context of the present patent application, to have particular implications with respect to the one or more signals being communicated, such as, for example, whether the signals are being communicated “to” a particular device, whether the signals are being communicated “from” a particular device, and/or regarding which end of a communication path may be initiating communication, such as, for example, in a “push type” of signal transfer or in a “pull type” of signal transfer. In the context of the present patent application, push and/or pull type signal transfers are distinguished by which end of a communications path initiates signal transfer.

Thus, a signal packet and/or frame may, as an example, be communicated via a communication channel and/or a communication path, such as comprising a portion of the Internet and/or the Web, from a site via an access node coupled to the Internet or vice-versa. Likewise, a signal packet and/or frame may be forwarded via network nodes to a target site coupled to a local network, for example. A signal packet and/or frame communicated via the Internet and/or the Web, for example, may be routed via a path, such as either being “pushed” or “pulled,” comprising one or more gateways, servers, etc. that may, for example, route a signal packet and/or frame, such as, for example, substantially in accordance with a target and/or destination address and availability of a network path of network nodes to the target and/or destination address. Although the Internet and/or the Web comprise a network of interoperable networks, not all of those interoperable networks are necessarily available and/or accessible to the public. According to an embodiment, a signal packet and/or frame may comprise all or a portion of a “message” transmitted between devices. In an implementation, a message may comprise signals and/or states expressing content to be delivered to a recipient device. For example, a message may at least in part comprise a physical signal in a transmission medium that is modulated by content that is to be stored in a non-transitory storage medium at a recipient device, and subsequently processed.

In the context of the particular patent application, a network protocol, such as for communicating between devices of a network, may be characterized, at least in part, substantially in accordance with a layered description, such as the so-called Open Systems Interconnection (OSI) seven layer type of approach and/or description. A network computing and/or communications protocol (also referred to as a network protocol) refers to a set of signaling conventions, such as for communication transmissions, for example, as may take place between and/or among devices in a network. In the context of the present patent application, the term “between” and/or similar terms are understood to include “among” if appropriate for the particular usage and vice-versa. Likewise, in the context of the present patent application, the terms “compatible with,” “comply with” and/or similar terms are understood to respectively include substantial compatibility and/or substantial compliance.

A network protocol, such as protocols characterized substantially in accordance with the aforementioned OSI description, has several layers. These layers are referred to as a network stack. Various types of communications (e.g., transmissions), such as network communications, may occur across various layers. A lowest level layer in a network stack, such as the so-called physical layer, may characterize how symbols (e.g., bits and/or bytes) are communicated as one or more signals (and/or signal samples) via a physical medium (e.g., twisted pair copper wire, coaxial cable, fiber optic cable, wireless air interface, combinations thereof, etc.). Progressing to higher-level layers in a network protocol stack, additional operations and/or features may be available via engaging in communications that are substantially compatible and/or substantially compliant with a particular network protocol at these higher-level layers. For example, higher-level layers of a network protocol may, for example, affect device permissions, user permissions, etc.

In one example embodiment, as shown in FIG. 3, a system embodiment may comprise a local network (e.g., device 804 and medium 840) and/or another type of network, such as a computing and/or communications network. For purposes of illustration, therefore, FIG. 3 shows an embodiment 800 of a system that may be employed to implement either type or both types of networks. Network 808 may comprise one or more network connections, links, processes, services, applications, and/or resources to facilitate and/or support communications, such as an exchange of communication signals, for example, between a computing device, such as 802, and another computing device, such as 806, which may, for example, comprise one or more client computing devices and/or one or more server computing device. By way of example, but not limitation, network 808 may comprise wireless and/or wired communication links, telephone and/or telecommunications systems, Wi-Fi networks, Wi-MAX networks, the Internet, a local area network (LAN), a wide area network (WAN), or any combinations thereof.

Example devices in FIG. 3 may comprise features, for example, of a client computing device and/or a server computing device, in an embodiment. It is further noted that the term computing device, in general, whether employed as a client and/or as a server, or otherwise, refers at least to a processor and a memory connected by a communication bus. A “processor” and/or “processing circuit” for example, is understood to connote a specific structure such as a central processing unit (CPU), digital signal processor (DSP), graphics processing unit (GPU) and/or neural network processing unit (NPU), or a combination thereof, of a computing device which may include a control unit and an execution unit. In an aspect, a processor and/or processing circuit may comprise a device that fetches, interprets and executes instructions to process input signals to provide output signals. As such, in the context of the present patent application at least, this is understood to refer to sufficient structure within the meaning of 35 USC § 112 (f) so that it is specifically intended that 35 USC § 112 (f) not be implicated by use of the term “computing device,” “processor,” “processing unit,” “processing circuit” and/or similar terms; however, if it is determined, for some reason not immediately apparent, that the foregoing understanding cannot stand and that 35 USC § 112 (f), therefore, necessarily is implicated by the use of the term “computing device” and/or similar terms, then, it is intended, pursuant to that statutory section, that corresponding structure, material and/or acts for performing one or more functions be understood and be interpreted to be described at least in FIGS. 1 and 2, and in the text associated with the foregoing figure(s) of the present patent application.

Referring now to FIG. 3, in an embodiment, first and third devices 802 and 806 may be capable of rendering a graphical user interface (GUI) for a network device and/or a computing device, for example, so that a user-operator may engage in system use. Device 804 may potentially serve a similar function in this illustration. Likewise, in FIG. 3, computing device 802 (‘first device’ in figure) may interface with computing device 804 (‘second device’ in figure), which may, for example, also comprise features of a client computing device and/or a server computing device, in an embodiment. Processor (e.g., processing device) 820 and memory 822, which may comprise primary memory 824 and secondary memory 826, may communicate by way of a communication bus 815, for example. The term “computing device,” in the context of the present patent application, refers to a system and/or a device, such as a computing apparatus, that includes a capability to process (e.g., perform computations) and/or store digital content, such as electronic files, electronic documents, measurements, text, images, video, audio, etc. in the form of signals and/or states. Thus, a computing device, in the context of the present patent application, may comprise hardware, software, firmware, or any combination thereof (other than software per se). Computing device 804, as depicted in FIG. 3, is merely one example, and claimed subject matter is not limited in scope to this particular example. FIG. 3 may further comprise a communication interface 830 which may comprise circuitry and/or devices to facilitate transmission of messages between second device 804 and first device 802 and/or third device 806 in a physical transmission medium over network 808 using one or more network communication techniques identified herein, for example. In a particular implementation, communication interface 830 may comprise a transmitter device including devices and/or circuitry to modulate a physical signal in physical transmission medium according to a particular communication format based, at least in part, on a message that is intended for receipt by one or more recipient devices. Similarly, communication interface 830 may comprise a receiver device comprising devices and/or circuitry demodulate a physical signal in a physical transmission medium to, at least in part, recover at least a portion of a message used to modulate the physical signal according to a particular communication format. In a particular implementation, communication interface may comprise a transceiver device having circuitry to implement a receiver device and transmitter device.

For one or more embodiments, a device, such as a computing device and/or networking device, may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, Internet of Things (IoT) type devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, GNSS receiver and/or other location-identifying type capability, and/or a display with a higher degree of functionality, such as a touch-sensitive color 5D or 3D display, for example.

In FIG. 3, computing device 802 may provide one or more sources of executable computer instructions in the form physical states and/or signals (e.g., stored in memory states), for example. Computing device 802 may communicate with computing device 804 by way of a network connection, such as via network 808, for example. As previously mentioned, a connection, while physical, may not necessarily be tangible. Although computing device 804 of FIG. 3 shows various tangible, physical components, claimed subject matter is not limited to a computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 822 may comprise any non-transitory storage mechanism. Memory 822 may comprise, for example, primary memory 824 and secondary memory 826, additional memory circuits, mechanisms, or combinations thereof may be used. Memory 822 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Memory 822 may be utilized to store a program of executable computer instructions. For example, processor 820 may fetch executable instructions from memory and proceed to execute the fetched instructions. Memory 822 may also comprise a memory controller for accessing device readable-medium 840 that may carry and/or make accessible digital content, which may include code, and/or instructions, for example, executable by processor 820 and/or some other device, such as a controller, as one example, capable of executing computer instructions, for example. Under direction of processor 820, a non-transitory memory, such as memory cells storing physical states (e.g., memory states), comprising, for example, a program of executable computer instructions, may be executed by processor 820 and able to generate signals to be communicated via a network, for example, as previously described. Generated signals may also be stored in memory, also previously suggested.

Memory 822 may store electronic files and/or electronic documents, such as relating to one or more users, and may also comprise a computer-readable medium that may carry and/or make accessible content, including code and/or instructions, for example, executable by processor 820 and/or some other device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Algorithmic descriptions and/or symbolic representations are examples of techniques used by those of ordinary skill in the signal processing and/or related arts to convey the substance of their work to others skilled in the art. An algorithm is, in the context of the present patent application, and generally, is considered to be a self-consistent sequence of operations and/or similar signal processing leading to a desired result. In the context of the present patent application, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

It has proven convenient at times, principally for reasons of common usage, to refer to such physical signals and/or physical states as bits, values, elements, parameters, symbols, characters, terms, samples, observations, weights, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically in the form of physical electronic and/or magnetic quantities, within memories, registers, and/or other storage devices, processing devices, and/or display devices of the special purpose computer and/or similar special purpose computing and/or network device. In the context of this particular patent application, as mentioned, the term “specific apparatus” therefore includes a general purpose computing and/or network device, such as a general purpose computer, once it is programmed to perform particular functions, such as pursuant to program software instructions.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation. Likewise, a physical change may comprise a transformation in molecular structure, such as from crystalline form to amorphous form or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state from a binary one to a binary zero or vice-versa in a memory device may comprise a transformation, such as a physical, but non-transitory, transformation. Rather, the foregoing is intended as illustrative examples.

Referring again to FIG. 3, processor 820 may comprise one or more circuits, such as digital circuits, to perform at least a portion of a computing procedure and/or process. By way of example, but not limitation, processor 820 may comprise one or more processors, such as controllers, microprocessors, microcontrollers, application specific integrated circuits, digital signal processors (DSPs), graphics processing units (GPUs), neural network processing units (NPUs), programmable logic devices, field programmable gate arrays, the like, or any combination thereof. In various implementations and/or embodiments, processor 820 may perform signal processing, typically substantially in accordance with fetched executable computer instructions, such as to manipulate signals and/or states, to construct signals and/or states, etc., with signals and/or states generated in such a manner to be communicated and/or stored in memory, for example.

FIG. 3 also illustrates device 804 as including a component 832 operable with input/output devices, for example, so that signals and/or states may be appropriately communicated between devices, such as device 804 and an input device and/or device 804 and an output device. A user may make use of an input device, such as a computer mouse, stylus, track ball, keyboard, and/or any other similar device capable of receiving user actions and/or motions as input signals. Likewise, for a device having speech to text capability, a user may speak to a device to generate input signals. A user may make use of an output device, such as a display, a printer, etc., and/or any other device capable of providing signals and/or generating stimuli for a user, such as visual stimuli, audio stimuli and/or other similar stimuli.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A method comprising:
defining a first mapping of an electronic document to a first encoded content domain;
defining a second mapping of the electronic document to a second encoded content domain; and
determining parameters for the first and second mappings based, at least in part, on a cross-correlation of features of the electronic document mapped to the first encoded content domain and features of the electronic document mapped to the second encoded content domain.

2. The method of claim 1, and further comprising:
mapping features of the electronic document encoded in the first encoded content domain and features of the electronic document encoded in the second encoded content domain to a common domain,
wherein the cross-correlation of features of the electronic document mapped to the first encoded content domain and features of the electronic document mapped to the second encoded content domain is determined based, at least in part, on a comparison of the features of the electronic document encoded in the first encoded content domain and the features of the electronic document encoded in the second encoded content domain mapped to the common domain.

3. The method of claim 1, wherein the first encoded content domain comprises text and the second encoded content domain comprises visual objects.

4. The method of claim 1, wherein:
the first mapping comprises at least a first neural network and the second mapping comprises a second neural network; and
the parameters for the first and second mappings comprise neural network weights.

5. The method of claim 1, wherein the electronic document comprises unlabeled content.

6. The method of claim 1, and further comprising:
defining compression processes to condition electronic content mapped to the first encoded domain and electronic content mapped to the second encoded domain for downstream processing.

7. The method of claim 1, wherein the electronic document comprises an audio signal, the first encoded domain comprises a voice-to-text transcription domain and the second domain sound features other than a human voice.

8. The method of claim 1, wherein features of the electronic document mapped to the first encoded domain is to provide a supervisory signal for determining parameters for the second mapping.

9. An apparatus comprising:
one or more memory devices; and
one or more processors operatively coupled to the one or more memory devices to:
define a first mapping of an electronic document to a first encoded content domain;
define a second mapping of the electronic document to a second encoded content domain; and
determine parameters for the first and second mappings based, at least in part, on a cross-correlation of features of the electronic document mapped to the first encoded content domain and features of the electronic document mapped to the second encoded content domain.

10. The apparatus of claim 9, wherein the one or more processors are further to:
map features of the electronic document encoded in the first encoded content domain and features of the electronic document encoded in the second encoded content domain to a common domain,
wherein the cross-correlation of features of the electronic document mapped to the first encoded content domain and features of the electronic document mapped to the second encoded content domain is determined based, at least in part, on a comparison of the features of the electronic document encoded in the first encoded content domain and the features of the electronic document encoded in the second encoded content domain mapped to the common domain.

11. The apparatus of claim 9, wherein the first encoded content domain comprises text and the second encoded content domain comprises visual objects.

12. The apparatus of claim 9, wherein:
the first mapping comprises at least a first neural network and the second mapping comprises a second neural network; and
the parameters for the first and second mappings comprise neural network weights.

13. The apparatus of claim 9, wherein the electronic document comprises unlabeled content.

14. The apparatus of claim 9, wherein the one or more processors are further to:
define compression processes to condition electronic content mapped to the first encoded domain and electronic content mapped to the second encoded domain for downstream processing.

15. The apparatus of claim 9, wherein the electronic document comprises an audio signal, the first encoded domain comprises a voice-to-text transcription domain and the second domain sound features other than a human voice.

16. The apparatus of claim 9, wherein features of the electronic document mapped to the first encoded domain is to provide a supervisory signal for determining parameters for the second mapping.

17. An article comprising:
a non-transitory storage medium comprising computer-readable instructions stored thereon, which are executable by one or more processors of a computing device to:
define a first mapping of an electronic document to a first encoded content domain;
define a second mapping of the electronic document to a second encoded content domain; and
determine parameters for the first and second mappings based, at least in part, on a cross-correlation of features of the electronic document mapped to the first encoded content domain and features of the electronic document mapped to the second encoded content domain.

18. The article of claim 17, wherein the instructions are further executable by the one or more processors to:
map features of the electronic document encoded in the first encoded content domain and features of the electronic document encoded in the second encoded content domain to a common domain,
wherein the cross-correlation of features of the electronic document mapped to the first encoded content domain and features of the electronic document mapped to the second encoded content domain is determined based, at least in part, on a comparison of the features of the electronic document encoded in the first encoded content domain and the features of the electronic document encoded in the second encoded content domain mapped to the common domain.

19. The article of claim 17, wherein the first encoded content domain comprises text and the second encoded content domain comprises visual objects.

20. The article of claim 17, wherein:
the first mapping comprises at least a first neural network and the second mapping comprises a second neural network; and
the parameters for the first and second mappings comprise neural network weights.
